(19) United States
(12) Patent Application Publication
(10) Pub. No.: US 2022/0390243 A1
(43) Pub. Date: Dec. 8, 2022

(54) VECTOR BASED SEARCH AND METHODS OF USING THE SAME

(71) Applicant: adVentures, Inc., Cle Elum, WA (US)

(72) Inventor: Garrison Prinslow, Reston, VA (US)

(21) Appl. No.: 17/833,857

(22) Filed: Jun. 6, 2022

Related U.S. Application Data
(60) Provisional application No. 63/197,488, filed on Jun. 6, 2021.

(51) Int. Cl. G01C 21/34; G01C 21/32; G01C 21/36

(52) U.S. Cl. CPC G01C 21/3415; G01C 21/32; G01C 21/3614; G01C 21/3476

(57) ABSTRACT

Various embodiments of the present application relate to a system architecture that employs vector-based data structures to translate a vector space into at least two dimensions so as to reduce computational expense, and increase operational speed during a search in the vector-space of points of interest along a user's pre-planned route. Further, the vector-based data structures allow for dynamic re-evaluation and re-routing of the user's existing route in substantially real-time, based on user feedback data including distance, location, velocity, and time.

### BACKGROUND

This section introduces aspects that may help facilitate a better understanding of the disclosure. Accordingly, these statements are to be read in this light and are not to be understood as admissions about what is or is not prior art.

Conventional system architectures related to searching are limited due to high computational expense and operational speed for user-desired content, based on a route that a user intends to travel. Additionally, conventional system architectures are limited in terms of the parameters that the user may employ to refine their searching. Various embodiments of the present disclosure address such issues.

### SUMMARY

One aspect of the present application relates to a system architecture that includes a first protocol. The first protocol is configured to receive input variables. The input variables include at least one point of interest criteria, and at least one tolerance parameter. The at least one tolerance parameter is entered by a user. The system architecture additionally includes a second protocol, wherein the second protocol is configured to transform the input variables from a first data format to a second data format. Moreover, the system architecture includes a third protocol, wherein the third protocol is configured to create a set of intermediate route points based on the input variables in the second data format.

Next, the system architecture includes a fourth protocol, wherein the fourth protocol is configured to calculate a vector-based detour search distance spanning from an intermediate route point of the set of intermediate route points based on the at least one tolerance parameter. This produces a calculated vector-based detour search distance for each intermediate route point of the set of intermediate route points.

The system architecture also includes a first procedure, wherein the first procedure is configured to produce a calculated vector-based detour distance point of interest. The first procedure includes a fifth protocol, wherein the fifth protocol is configured to determine whether a point of interest based on the at least one point of interest criteria is within the calculated vector-based detour search distance.

Additionally, the first procedure includes a sixth protocol, wherein the sixth protocol is configured to calculate a vector-based detour distance from each intermediate route point of the set of intermediate route points to the point of interest, wherein the vector-based detour distance is within the calculated vector-based detour search distance. This produces a calculated vector-based detour distance for the each intermediate route point of the set of intermediate route points.

Next, the first procedure includes a seventh protocol, wherein the seventh protocol is configured to save the point of interest as a geographical vector-coordinate pair, wherein the geographical vector-coordinate pair includes the point of interest and the calculated vector-based detour distance. In one or more embodiments, the point of interest is within the calculated vector-based detour search distance.

Reverting to the system architecture, an eighth protocol is configured to produce, by iterating the first procedure, a set of calculated vector-based detour distance based on geographical vector-coordinate pairs. The system architecture additionally includes a ninth protocol, wherein the ninth protocol is configured to return the set of calculated vector-based detour distance to a user device, thereby conducting the vector-based search based on the geographical vector-coordinate pairs.

Another aspect of the present application relates to a non-transitory computer-readable medium encoded with a computer-readable program, when executed by a processor, will cause a computer to execute a method of conducting a vector-based search based on geographical vector-coordinate pairs, wherein the method includes receiving input variables. The input variables include at least one point of interest criteria, and at least one tolerance parameter. The at least one tolerance parameter is entered by a user. The method additionally includes transforming the input variables from a first data format to a second data format. Moreover, the method includes creating a set of intermediate route points based on the input variables in the second data format.

Next, the method includes calculating a vector-based detour search distance spanning from an intermediate route point of the set of intermediate route points based on the at least one tolerance parameter. This produces a calculated vector-based detour search distance for each intermediate route point of the set of intermediate route points.

The method also includes performing a first procedure, wherein the first procedure is configured to produce a calculated vector-based detour distance point of interest. The first procedure includes determining whether a point of interest based on the at least one point of interest criteria is within the calculated vector-based detour search distance.

Additionally, the method includes calculating a vector-based detour distance from each intermediate route point of the set of intermediate route points to the point of interest, wherein the vector-based detour distance is within the calculated vector-based detour search distance. This produces a calculated vector-based detour distance for e each intermediate route point of the set of intermediate route points.

Next, the first procedure includes saving the point of interest as a geographical vector-coordinate pair, wherein the geographical vector-coordinate pair includes the point of interest and the calculated vector-based detour distance. In one or more embodiments, the point of interest is within the calculated vector-based detour search distance.

Reverting to the method, the next step follows with producing, by iterating the first procedure, a set of calculated vector-based detour distance based on geographical vector-coordinate pairs. The method additionally includes returning the set of calculated vector-based detour distance to a user device, thereby conducting the vector-based search based on the geographical vector-coordinate pairs.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates one example of a computing or processing node 1500 for operating a method or a software architecture in accordance with the present application.

### DETAILED DESCRIPTION

The following disclosure provides many different embodiments, or examples, for implementing different features of the present application. Specific examples of components and arrangements are described below simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiments) herein and/or variations thereof.

Various embodiments of the present application relate to a system architecture that employs vector-based data structures to translate a vector space into at least two dimensions so as to reduce computational expense, and increase operational speed during a search in the vector-space of points of interest along a user's pre-planned route. Further, the vector-based data structures allow for dynamic re-evaluation and re-routing of the user's existing route in substantially real-time based on user feedback data including distance, location, velocity, and time.

The vector-based data structures allow fora range of parameters which are updated in substantially real-time to reduce the computational expense and increase efficiency, depending on the number of the user's route-varying decision points. For example, it may be most efficient to only search for detours to the point of interest from the user's potential decision points along a route (such as exits from a freeway, of intersections on a road), rather than constantly searching based on the user location as the user navigates through the route. The vector-based data structures allow storage and reliance on prior searches for route-varying decision points and/or points of interest, so that such prior searches are reused if the criteria are within a certain tolerance of similarity.

Example 1: A system architecture includes a first protocol. The first protocol is configured to receive input variables. The input variables include at least one point of interest criteria, and at least one tolerance parameter. The at least one tolerance parameter is entered by a user. The system architecture additionally includes a second protocol, wherein the second protocol is configured to transform the input variables from a first data format to a second data format. Moreover, the system architecture includes a third protocol, wherein the third protocol is configured to create a set of intermediate route points based on the input variables in the second data format.

Next, the system architecture includes a fourth protocol, wherein the fourth protocol is configured to calculate a vector-based detour search distance spanning from an intermediate route point of the set of intermediate route points based on the at least one tolerance parameter. This produces a calculated vector-based detour search distance for each intermediate route point of the set of intermediate route points.

The system architecture also includes a first procedure, wherein the first procedure is configured to produce a calculated vector-based detour distance point of interest. The first procedure includes a fifth protocol, wherein the fifth protocol is configured to determine whether a point of interest based on the at least one point of interest criteria is within the calculated vector-based detour search distance.

Additionally, the first procedure includes a sixth protocol, wherein the sixth protocol is configured to calculate a vector-based detour distance from each intermediate route point of the set of intermediate route points to the point of interest, wherein the vector-based detour distance is within the calculated vector-based detour search distance. This produces a calculated vector-based detour distance for the each intermediate route point of the set of intermediate route points.

Next, the first procedure includes a seventh protocol, wherein the seventh protocol is configured to save the point of interest as a geographical vector-coordinate pair, wherein the geographical vector-coordinate pair includes the point of interest and the calculated vector-based detour distance. In one or more embodiments, the point of interest is within the calculated vector-based detour search distance.

Reverting to the system architecture, an eighth protocol is configured to produce, by iterating the first procedure, a set of calculated vector-based detour distance based on geographical vector-coordinate pairs. The system architecture additionally includes a ninth protocol, wherein the ninth protocol is configured to return the set of calculated vector-based detour distance to a user device, thereby conducting the vector-based search based on the geographical vector-coordinate pairs.

In at least one embodiment, the point of interest is within the calculated vector-based detour distance.

In one or more embodiments, the input variables further include a route-based start point and a route-based end point. In some embodiments, the at least one tolerance parameter is configured to assess a detour distance from a route based on at least time or distance.

In at least one embodiment, the second data format includes two-dimensional cartesian coordinate vector pairs. In at least one embodiment, the set of intermediate route points represent route decision points between a start point and an end point. In at least one embodiment, the fourth protocol includes at feast one of tangent-based distance, radius-based distance, or vector-based distance.

In one or more embodiments, the geographical vector-coordinate pairs include a first coordinate and a second coordinate. In some embodiments, the first coordinate is based on a first latitude and a first longitude; and the second coordinate is based on a second latitude and a second longitude. In some embodiments, first coordinate and the second coordinate are based on cartesian coordinate points.

In at least one embodiment, the at least one point of interest criteria includes a text phrase or hashtag. In at least one embodiment, the first data format includes at least one of city and state, address, or an address including the city and state. In at least one embodiment, the set of intermediate route points includes at least one of intersections of a street, exit points of a highway, or transit stops of a transit route.

Example 2: A non-transitory computer-readable medium encoded with a computer-readable program, when executed by a processor, will cause a computer to execute a method of conducting a vector-based search based on geographical vector-coordinate pairs, wherein the method includes receiving input variables. The input variables include at least one point of interest criteria, and at least one tolerance parameter. The at least one tolerance parameter is entered by a user. The method additionally includes transforming the input variables from a first data format to a second data format. Moreover, the method includes creating a set of intermediate route points based on the input variables in the second data format.

Next, the method includes calculating a vector-based detour search distance spanning from an intermediate route point of the set of intermediate route points based on the at least one tolerance parameter. This produces a calculated vector-based detour search distance for each intermediate route point of the set of intermediate route points.

The method also includes performing a first procedure, wherein the first procedure is configured to produce a calculated vector-based detour distance point of interest. The first procedure includes determining whether a point of interest based on the at least one point of interest criteria is within the calculated vector-based detour search distance.

Additionally, the method includes calculating a vector-based detour distance from each intermediate route point of the set of intermediate route points to the point of interest, wherein the vector-based detour distance is within the calculated vector-based detour search distance. This produces a calculated vector-based detour distance for the each intermediate route point of the set of intermediate route points.

Next, the first procedure includes saving the point of interest as a geographical vector-coordinate pair, wherein the geographical vector-coordinate pair includes the point of interest and the calculated vector-based detour distance. In one or more embodiments, the point of interest is within the calculated vector-based detour search distance.

Reverting to the method, the next step follows with producing, by iterating the first procedure, a set of calculated vector-based detour distance based on geographical vector-coordinate pairs. The method additionally includes returning the set of calculated vector-based detour distance to a user device, thereby conducting the vector-based search based on the geographical vector-coordinate pairs.

In at least one embodiment, the point of interest is within the calculated vector-based detour distance.

In one or more embodiments, the input variables further include a route-based start point and a route-based end point. In some embodiments, the at least one tolerance parameter is configured to assess a detour distance from a route based on at least time or distance.

In at least one embodiment, the second data format includes two-dimensional cartesian coordinate vector pairs. In at least one embodiment, the set of intermediate route points represent route decision points between a start point and an end point. In at least one embodiment, the fourth protocol includes at least one of tangent-based distance, radius-based distance, or vector-based distance.

In one or more embodiments, the geographical vector-coordinate pairs include a first coordinate and a second coordinate. In some embodiments, the first coordinate is based on a first latitude and a first longitude; and the second coordinate is based on a second latitude and a second longitude. In some embodiments, first coordinate and the second coordinate are based on cartesian coordinate points.

In at least one embodiment, the at least one point of interest criteria includes a text phrase or hashtag. In at least one embodiment, the first data format includes at least one of city and state, address, or an address including the city and state. In at least one embodiment, the set of intermediate route points includes at least one of intersections of a street, exit points of a highway, or transit stops of a transit route.

One of ordinary skill in the art would recognize that operations are added or removed from the above method, in one or more embodiments. One of ordinary skill in the art would also recognize that the order of the operations in the above method is varied in various alternative embodiments.

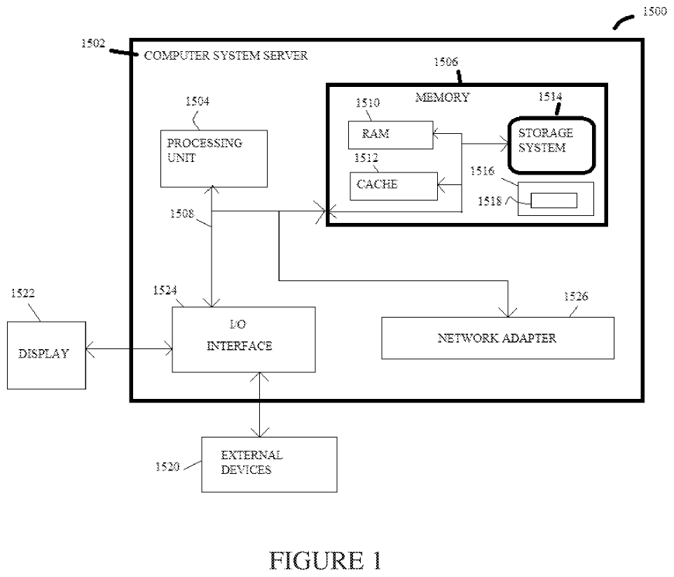

FIG. 1 illustrates one example of a computing or processing node 1500 for operating the methods and the software architecture of the present application. This is not intended to suggest any limitation as to the scope of use or functionality of embodiments of the invention described herein. Regardless, the computing node 1500 is capable of being implemented and/or performing any of the functionality set forth hereinabove.

In computing node 1500 there is a computer system/server 1502, which is operational with numerous other general purpose or special purpose computing system environments or configurations. Examples of well-known computing systems, environments, and/or configurations that array be suitable for use with computer system/server 1502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 1502 in cloud computing node 1500 is shown in the form of a general-purpose computing device. The components of computer system/server 1502 may include, but are not limited to, one or more processors or processing units 1504, a system mentor) 1506, and a bus 1508 that couples various system components including system memory 1506 to processor 1504.

Bus 1508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1502 typically includes a variety of computer system readable media. Such media may be any available media that is accessible by computer system/server 1502, and it includes both volatile and non-volatile media, removable and non-removable media.

System memory 1506, in one embodiment, implements the methods and the software architectures of the present application. The system memory 506 can include computer system readable media in the form of volatile memory, such as random access memory (RAM) 1510 and/or cache memory 1512. Computer system/server 1502 may further include other removable/non-removable, volatile/non-volatile computer system storage media. By way of example only, storage system 1514 can be provided for reading from and writing to a non-removable non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1508 by one or more data media interfaces. As will be further depicted and described below, memory 1506 may include at least one program product having a set (e at least one) of program modules that are configured to carry out the functions of various embodiments of the invention.

Program/utility 1516, having a set (at least one) of program modules 1518, may be stored in memory 1506 by way of example, and not limitation, as well as an operating system, one or more application programs, other program modules, and program data. Each of the operating system, one or more application programs, other program modules, and program data or some combination thereof, may include an implementation of a networking environment. Program modules 1518 generally carry out the functions and/or methodologies of various embodiments of the invention as described herein.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer system/server 1502 may also communicate with one or more external devices 1520 such as a keyboard, a pointing device, a display 1522, etc.; one or more devices that enable a user to interact with computer system/server 1502; and/or any devices (e.g., network card, modem, etc.) that enable computer system/server 1502 to communicate with one or more other computing devices. Such communication can occur via I/O interfaces 1524. Still yet, computer system/server 1502 can communicate with one or more networks such as a local area network (LAN), a general wide area network (WAN), and/or a public network the Internet) via network adapter 1526. As depicted, network adapter 1526 communicates with the other components of computer system/server 1502 via bus 1508. It should be understood that although not shown, other hardware and/or software components could be used in conjunction with computer system/server 1502. Examples, include, but are not limited to: microcode, device drivers, redundant processing units, external disk drive arrays, RAID systems, tape drives, and data archival storage systems, etc.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include in their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intentions not to be limited to the details given herein. For example, the various elements or components may be combined or integrated in another system or certain features may be omitted, or not implemented.

1. A non-transitory computer-readable medium encoded with a computer-readable program, when executed by a processor, will cause a computer to execute a method of conducting a vector-based search based on geographical vector-coordinate pairs, wherein the method comprises:
receiving input variables, wherein the input variables comprise at least one point of interest criteria, and at least one tolerance parameter;
transforming the input variables from a first data format to a second data format creating a set of intermediate route points based on the input variables in the second data format;
calculating a vector-based detour search distance spanning from an intermediate route point of the set of intermediate route points based on the at least one tolerance parameter, thereby producing a calculated vector-based detour search distance for each intermediate route point of the set of intermediate route points;
performing a first procedure, wherein the first procedure is configured to produce a calculated vector-based detour distance point of interest, wherein the first procedure comprises:
determining whether a point of interest based on the at least one point of interest criteria is within the calculated vector-based detour search distance;
calculating a vector-based detour distance from the each intermediate route point of the set of intermediate route points to the point of interest which is within the calculated vector-based detour search distance, thereby producing a calculated vector-based detour distance for the each intermediate route point of the set of intermediate route points;
saving the point of interest as a geographical vector-coordinate pair, wherein the point of interest in within the calculated vector-based detour search distance, wherein the geographical vector-coordinate pair comprises the point of interest and the calculated vector-based detour distance;
producing, by iterating the first procedure, a set of calculated vector-based detour distance based on geographical vector-coordinate pairs; and
returning the set of calculated vector-based detour distance to a user device, thereby conducting the vector-based search based on the geographical vector-coordinate pairs.

2. The method of claim 1, wherein the point of interest is within the calculated vector-based detour distance.

3. The method of claim 1, wherein the input variables further comprise:
a route-base start point and a route-based end point.

4. The method of claim 3, wherein the at least one tolerance parameter is configured to assess a detour distance from a route based on at least time or distance. The method of claim 1, wherein the second data format comprises two-dimensional cartesian coordinate vector pairs.

6. The method of claim 1, wherein the set of intermediate route points represent route decision points between a start point and an end point.

7. The method of claim 1, wherein the fourth protocol comprises at east one of tangent-based distance, radius-based distance, or vector-based distance.

8. The method of claim 1, wherein the geographical vector-coordinate pairs comprise a first coordinate and a second coordinate.

9. The method of claim 8, wherein the first coordinate is based on a first latitude and a first longitude, and the second coordinate is based on a second latitude and a second longitude.

10. The method of claim 8, wherein the first coordinate and the second coordinate are based on cartesian coordinate points.

11. The method of claim 1, wherein the at least one point of interest criteria comprises a text phrase or hashtag.

12. The method of claim 1, wherein the first data format comprises at east one of city and state, address, or an address including the city and state.

13. The method of claim 1, wherein the set of intermediate route points comprises at least one of intersections of a street, exit points of a highway, or transit stops of a transit route.
